(19) United States
(12) Patent Application Publication
(10) Pub. No.: US 2014/0048097 A1
(43) Pub. Date: Feb. 20, 2014

(54) SURFACE OXIDE REMOVAL METHODS

(71) Applicant: IDev Technologies, Inc., Webster, TX (US)

(72) Inventors: Kenneth M. Bueche, Friendswood, TX (US); Sepehr Fariabi, Newport Coast, CA (US); Rodolfo Moreno, III, Pearland, TX (US); Milagros P. Sapinoso, Deer Park, TX (US)

(73) Assignee: IDev Technologies, Inc., Webster, TX (US)

(21) Appl. No.: 13/966,638

(22) Filed: Aug. 15, 2013

Related U.S. Application Data
(60) Provisional application No. 61/684,639, filed on Aug. 17, 2012.

(51) Int. Cl. B08B 3/12; B08B 3/08

(52) U.S. Cl. CPC B08B 3/12; B08B 3/08
USPC 134/1

(57) ABSTRACT

Methods of treating a device such as an endoprostheses or a batch thereof include first soaking the device in nitric acid for greater than 1 hour; after first soaking the device, first sonicating the device in deionized water for between about 5 minutes and about 20 minutes; and after first sonicating the device, repeating, at least once, soaking the device in nitric acid for greater than 1 hour, and, after soaking the device in the nitric acid, sonicating the device in deionized water between about 5 minutes and about 20 minutes. Methods may further include soaking in a mild acid for between about 30 minutes and about 45 minutes. The methods may form a protective oxide having a thickness between about 30 Å and about 100 Å.

### CROSS-REFERENCE TO RELATED APPLICATIONS

The present application claims priority benefit under 35 U.S.C. §119(e) of U.S. Provisional Application Ser. No. 61/684,639, filed Aug. 17, 2012, entitled “Surface Oxide Removal Methods,” the disclosure of which is incorporated herein by reference in its entirety.

### BACKGROUND

1. Field

The present application relates to the removal of surface oxide from devices such as endoprostheses.

2. Description of the Related Art

Nitinol, which is an alloy comprising nickel and titanium, is used to form prosthetic devices such as stents for placement in body lumens due to its biocompatibility and shape-retention properties. For example, when placed in a biliary duct or blood vessel in a compressed state, a stent comprising nitinol can “self-expand” to an expanded state to, for example, maintain patency of the lumen. Nitinol that has been drawn through a die (e.g., a diamond die or a carbide die) to conform to a dimension such as thickness or diameter generally include an oxide (e.g., titanium oxide, nickel oxide, and/or nickel-titanium-oxide), for example acting as a lubricant. Such “non-protective” oxide may be non-uniform, affect the physical properties of the wire, include pits that could initiate thrombosis, incorporate some metals, have a porosity that allows leaching of metals through the oxide, be prone to sloughing off, and/or the like, any of which could negatively affect the biocompatibility of devices comprising the nitinol wire. The thickness of the non-protective oxide may be increased during forming devices comprising the nitinol, for example due to exposure to ambient oxygen during formation and/or during shape setting heat treatment (e.g., imparting a final shape to an endoprosthesis at a temperature between about 400 degrees Celsius (° C.) and about 1,000° C.), which could maintain and/or exacerbate these disadvantages. An oxide resulting from die drawing and heat treatment in an inert heat treatment (e.g., in argon) may be defined as a “light oxide.” Light oxides may be thin and uniform (e.g., greater than about 0.0001 inches (approx. 2.5 micrometers (μm))). An oxide resulting from die drawing and heat treatment in a non-inert heat treatment (e.g., in air comprising oxygen) may be defined as a “heavy oxide” or “dark oxide.” Heavy oxides may be thicker than light oxides (e.g., greater than about 0.0002 inches (approx. 5 μm). Other materials used for endoprostheses, including for example stainless steel and chromium cobalt alloys, may also comprise oxides.

### SUMMARY

After removal of non-protective surface oxide, a potentially toxic metal surface is exposed. Passivation generally forms a controlled inert protective oxide over a potentially toxic metal surface. Various standards have been established for passivating devices such as stents used inside of a human or animal body, but these standards are typically silent about oxide properties that could negatively affect biocompatibility. Additionally, previous non-protective oxide removal processes followed serially by passivation may not be suitable for certain devices, for example due to removing too much underlying material. Certain methods described herein can remove non-protective oxides by cycling soaking in nitric acid for greater than 1 hour and sonicating in deionized water for between about 5 minutes and about 20 minutes and can form protective oxides that are thin (e.g., between about 30 angstroms (Å) and about 100 Å (between about 0.3 μm and about 1 μm)) and uniform or substantially uniform.

In some embodiments, a method of treating a device comprises first soaking the device in nitric acid for greater than 1 hour; after first soaking the device, first sonicating the device in deionized water for between about 5 minutes and about 20 minutes; and after first sonicating the device, repeating, at least once: soaking the device in nitric acid for greater than 1 hour, and after soaking the device in the nitric acid, sonicating the device in deionized water for between about 5 minutes and about 20 minutes.

The device may comprise nitinol. Before first soaking the device, the device may comprise non-protective oxide at least partially covering the nitinol. Repeating the soaking and sonicating may be at least 2 times. Repeating the soaking and sonicating may be at least 10 times. At least one of first soaking and soaking during repeating may include soaking the device in nitric acid for between greater than 1 hour and about 2 hours. At least one of first soaking and soaking during repeating may include soaking the device in nitric acid for between greater than 1 hour and about 3 hours. At least one of first soaking and soaking during repeating may include soaking the device in nitric acid for between greater than 1 hour and about 4 hours. At least one of first sonicating and sonicating during repeating may include sonicating the device in deionized water for about 10 minutes. At least one of first soaking and soaking during repeating may include stirring during soaking. Stirring may be between about 200 rotations per minute (rpm) and about 300 rpm. At least one of first soaking and soaking during repeating may include sonicating during soaking. At least one of first sonicating and sonicating during repeating may include sonicating the device in deionized water at least two times. At least one of first sonicating and sonicating during repeating may include sonicating the device in deionized water for about 10 minutes at least two times. At least one of first sonicating and sonicating during repeating may include rinsing nitric acid from the device. The method may further comprise, during repeating, inspecting the device. Inspecting may comprise using at least one of an optical microscope and a scanning electron microscope. Inspecting the device may influence a number of times of repeating. The method may further comprise, after repeating, lastly soaking the device in nitric acid for between about 30 minutes and about 60 minutes. The method may further comprise, after repeating, lastly soaking the device in nitric acid for between about 30 minutes and about 45 minutes. The method may further comprise, before first soaking, initially sonicating the device. Initially sonicating the device may include sonicating in a solution including sodium hydroxide. Initially sonicating the device may include sonicating in deionized water. After the method, the device may comprise an oxide layer having a thickness between about 30 Å and about 100 Å (between about 0.3 micrometers μm and about 1 μm). The device may comprise an endoprosthesis. The endoprosthesis may comprise a stent. The stent may comprise a woven stent. The woven stent may comprise nitinol strands. The stent may comprise a laser-cut stent. The laser-cut stent may comprise nitinol. The method may comprise processing a plurality of the devices in a batch. The batch may comprise at least about 25 devices.

For purposes of summarizing the invention and the advantages achieved over the prior art, certain objects and advantages of the invention are described herein. Of course, it is to be understood that not necessarily all such objects or advantages need to be achieved in accordance with any particular embodiment. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 illustrates an example method for passivating an endoprosthesis.

FIG. 2 illustrates an example system for soaking an endoprosthesis.

FIG. 3 illustrates examples of non-protective oxide delaminating from a surface of an endoprosthesis.

FIG. 4 illustrates examples of a passivated surface of an endoprosthesis.

FIG. 5 is an Auger depth profile of a first portion of a passivated surface of a sterilized endoprosthesis.

FIG. 6 illustrates the first portion of the passivated surface of the sterilized endoprosthesis of FIG. 6 at various magnifications.

FIG. 7 is an Auger depth profile of a second portion of the passivated surface of the sterilized endoprosthesis of FIG. 6.

FIG. 8 illustrates the second portion of the passivated surface of the sterilized endoprosthesis of FIG. 6 at various magnifications.

### DETAILED DESCRIPTION

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

In general, passivation is the chemical treatment of a metallic part comprising, for example, stainless steel and/or nitinol, with a mild oxidant, such as nitric acid (HNO₃) solution, for the purpose of removing free iron (e.g., from stainless steel), nickel (e.g., from nitinol), and/or other foreign matter. This process generally is not effective at, or intended for, removing oxide scale, for example the light oxide and heavy oxide described herein, from the metallic part. For example, nitinol endoprostheses generally include surface oxide scales formed of Ti₃Ti, Ni₄Ti, Ni, and/or TiO₂. These nitinol oxide scales are typically removed by a separate process such as pickling/etching (mix of nitric acid, hydrofluoric acid, and water; mix of nitric acid, ammonium difluoride, and water; etc.), centerless grinding, sandblasting, electropolishing (EP), combinations thereof, and/or the like. Certain of these non-protective oxide removal techniques such as sand blasting and electropolishing may disadvantageously remove not only the oxide, but also undesirably some amount of base material, for example making them unsuitable for use with woven stents or other devices including relatively small dimensions (e.g., less than about 0.01 inches (approx. 0.25 mm)).

After the non-protective oxide is removed, the endoprosthesis is passivated and/or cleaned. For example, passivating the endoprosthesis may comprise soaking the endoprosthesis for between 30 minutes and 45 minutes in a nitric acid bath. The nitric acid bath may be commercially purchased and then diluted to 20-50% v/v with water. The soaking may be in accordance with American Society for Testing and Materials (ASTM) standards for forming a thin passivating oxide, such as ASTM A967-05 (e.g., ASTM A967-05, which is incorporated herein by reference in its entirety), or a modification thereof. Soaking in nitric acid may form a protective oxide on the surface of the endoprosthesis. A single or low multiple number of soaks in nitric acid, even if for greater than one hour in duration, does not remove non-protective oxide, and may be performed after a different process removes non-protective oxide. Rather, such nitric acid treatments are used for forming a protective oxide after a previous non-protective oxide removal process.

Table 1 shows example data for oxide layer thickness using such a passivation process after a separate non-protective oxide removal step, as determined by Auger Electron Spectroscopy (AES) of various samples.

TABLE 1
Oxide Layer Characterization - AES Sputtering

| Oxide Layer | Phases within | |
|---|---|---|
| Thickness (nm) | Oxide Layer | Final Surface Processing |
| 38 to 82 | No report | EP + thermal oxide + simulated |
| | | coating process |
| 2.8 | No report | EP |
| 3 to 10 | TiO₂ | EP |
| 80 to 120 | TiO₂ | No Report |

There are currently no acceptance criteria for endoprosthesis protective oxide layer thickness. However, during a Food and Drug Administration (FDA) Workshop on Mar. 8, 2012 in Silver Spring, Md., Session #2: Surface Characterization of Nickel-Containing Alloys, the following nitinol oxide thickness guideline was discussed:

<15 nm, no Ni-rich phases

<50 nm, <20 atomic % Ni-rich regions

<10 nm (guideline)

Referring again to Table 1, only two of the oxide layer characterizations would achieve the most rigorous of the proposed guidelines. However, these results may not be achievable for every type or configuration of endoprosthesis. For example, a thin wire may be difficult to electropolish because too much material is lost, compromising the physical characteristics of the wire, causing pitting, etc.

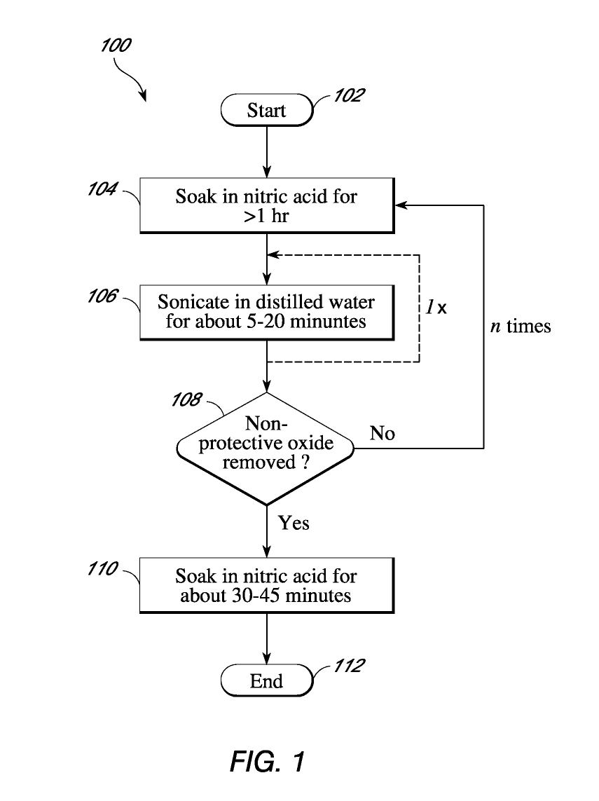

FIG. 1 illustrates an example method 100 for passivating an endoprostheses. The method 100 begins at Start 102 with an endoprosthesis including an initial non-protective oxide. The non-protective oxide may have a thickness less than about 2.5 μm, less than about 5 μm, less than 2.5 μm, or less than 5 μm, for example depending on the ambient gases during a heat treatment process. The initial oxide may be fairly uniform, for example if not heat treated or if heat treated in an inert atmosphere, or may lack uniformity, for example if heat treated in an oxygen atmosphere.

In some embodiments, the endoprosthesis passivated by the method 100 comprises a stent comprising woven (e.g., plain woven) strands (e.g., nitinol strands). For example, the endoprosthesis may comprise a SUPERA® stent, available from IDev Technologies, Inc. In some embodiments, the endoprosthesis passivated by the method 100 comprises a laser-cut stent formed from a tube or sheet (e.g., comprising nitinol). In some embodiments, the endoprosthesis passivated by the method 100 comprises a filter, angioplasty device, catheter component, or other endoluminal device, dental implant, orthodontic wire, heart valves, sensors, or any other device that may be placed or implanted in a body. Although primarily described herein with respect to endoprostheses, the methods described herein may also be used for any device comprising nitinol, titanium alloys, and stainless steel. For example, devices may include components for robotics (e.g., muscle wires), toys, electronics, space (e.g., satellites), and deep water, springs, couplings (e.g., aircraft or automotive couplings), superelastic wires, utensils (e.g., cutlery), textiles, filters, and the like. The device may be formed from wires, machined, cast, milled, and the like. In some embodiments, the endoprosthesis passivated by the method 100 comprises a woven or laser-cut stent, or other type of endoprosthesis, comprising a material other than nitinol. In some embodiments, the method 100 may be used for devices such as medical devices other than endoprostheses.

After Start 102, the endoprosthesis is soaked in nitric acid for greater than one hour at box 104. The nitric acid may be in accordance with ASTM A967-05, for example being between about 45 vol % and about 55 vol %, or between 45 vol % and 55 vol %, in water. The soaking 104 may be at a temperature between about 30° C. and about 60° C., between 30° C. and 60° C., between about 40° C. and about 50° C., between 40° C. and 50° C., between about 40° C. and about 45° C. (e.g., about 43° C.), between 40° C. and 45° C. (e.g., 43° C.), combinations thereof, and/or temperatures and temperature ranges included therein. The soaking 104 may include stirring, for example with a magnetic stirrer. The magnetic stirrer may spin at a rate between about 200 rpm and about 300 rpm (e.g., about 250 rpm) or between 200 rpm and 300 rpm (e.g., 250 rpm), depending on volume, stirrer dimensions, desired circulation, etc. The soaking 104 may be in a beaker having a basket configured to hold the endoprosthesis, and the stirrer may be between the beaker and the basket.

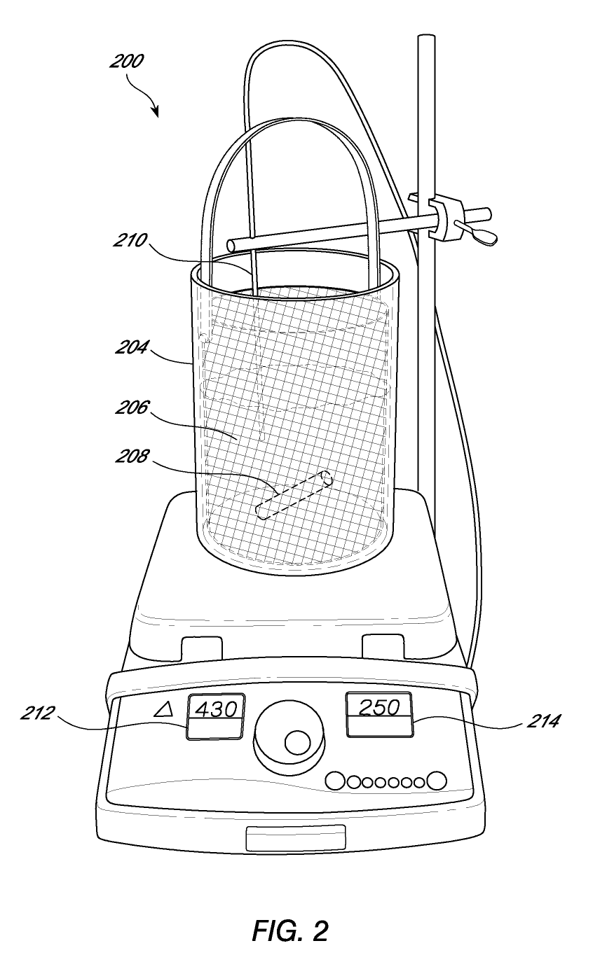

The soaking 104 may be on a hotplate, for example configured to maintain the temperature of the nitric acid and/or to provide stirring to the nitric acid. FIG. 2 illustrates an example system 200 for soaking one or more endoprostheses. The system 200 includes a hotplate 202, for example an Isotemp Digital Stirring Hotplate, available from Fisher Scientific. The system further comprises a beaker 204, basket 206, and stirrer 208 (in phantom) between the beaker 204 and the basket 206. The hotplate 202 may include a magnet and motor configured to rotate the stirrer 208 via magnetic field to provide stirring to the nitric acid in the beaker 204. The system 200 illustrated in FIG. 2 may be contained in a ventilated hood. The hotplate 202 may maintain temperature using a thermometer 210 configured to provide information regarding the temperature of the nitric acid, and the hotplate 202 may increase or decrease the temperature accordingly. The thermometer 210 preferably does not touch the sides or bottom of the beaker 204, the basket 206, or any endoprostheses therein. In FIG. 2, the display portion 212 of the hotplate 202 shows that the temperature of the nitric acid is 43.0° C., and the display portion 214 of the hotplate 202 shows that the stirring is at 250 rpm.

In some embodiments, the soaking 104 may include sonicating that is separate from the sonicating 106 described herein, for example including applying sound energy to the nitric acid. In some embodiments, sonicating during soaking 104 uses a power/volume ratio between about 50 watts/gallon (W/gal) (approx. 13 W/L) and about 300 W/gal (approx. 79 W/L), between 50 W/gal (approx. 13 W/L) and 300 W/gal (approx. 79 W/L), between about 100 W/gal (approx. 26 W/L) and about 150 W/gal (approx. 40 W/L), between 100 W/gal (approx. 26 W/L) and 150 W/gal (approx. 40 W/L), combinations thereof, and/or ratios therebetween. In some embodiments, sonicating during soaking 104 is at a frequency between about 38 kilohertz (kHz) and about 40 kHz or between 38 kHz and 40 kHz.

Referring again to FIG. 1, before, after, and/or during soaking at box 104, the endoprosthesis may be rinsed with deionized water. In some embodiments, the endoprosthesis may be moved directly from the nitric acid to a sonicator containing deionized water without separate rinsing.

In some embodiments, the duration of the soaking 104 is between greater than 1 hour and about 3 hours, or between greater than 1 hour and 3 hours. Longer soaking 104 durations (e.g., greater than about 3 hours) may provide little or modest benefit, perhaps because the nitric acid baths become too mucky to have further effect, and/or because the nitric acid may have only a certain level of effect until sonicating 106 is needed to dislodge some non-protective oxide slough. Nevertheless, durations for soaking 104 longer than about 3 hours are also possible (e.g., about 3.5 hours, about 4 hours, about 5 hours, about 6 hours, about 9 hours, about 10 hours, about 12 hours, about 24 hours, and ranges including the foregoing durations). Durations for soaking 104 shorter than about 3 hours are also possible (e.g., about 1.5 hours, about 2 hours, about 2.5 hours, and ranges including the foregoing durations). Durations of soaking 104 longer than 1 hour may reduce the number of cycles of soaking 104 and sonicating 106 to achieve removal of non-protective oxides. In some embodiments, duration of soaking 104 is between greater than 1 hour and about 12 hours, between greater than 1 hour and 12 hours, between about 1.5 hours and about 6 hours, between 1.5 hours and 6 hours, between about 2 hours and about 4 hours, between 2 hours and 4 hours, greater than about 1.5 hours, greater than 1.5 hours, greater than about 2 hours, greater than 2 hours, greater than about 2.5 hours, greater than 2.5 hours, and ranges including the foregoing durations.

Other factors may also contribute to duration of the soaking 104. For example, it will be appreciated that volumes, volume/endoprosthesis ratios, concentrations, etc. may also impact the durations described herein. As an example, soaking a single endoprosthesis in 40 liters of concentrated nitric acid may have a different effect than soaking ten endoprostheses in 200 mL of dilute nitric acid, even if for the same duration. In some embodiments, soaking 104 includes using between about 60 mL and about 70 mL or between 60 mL and 70 mL of nitric acid (50 vol %) per endoprosthesis.

Adjustments to the soaking 104 other than duration are also contemplated. For example, higher concentrations of nitric acid (e.g., about 70 vol %, 70 vol %), higher temperatures, additives such as hydrofluoric acid (HF) at between about 1 vol % and about 3 vol % or between 1 vol % and 3 vol %, and other modifications to the soaking 106 can reduce the soaking 104 duration that would cause a similar effect, but may cause etching or pitting of the underlying metal and/or may be difficult to control.

After soaking 104 in the nitric acid, the endoprosthesis is sonicated in deionized water for between about 5 minutes and about 20 minutes, or between 5 minutes and 20 minutes, at box 106. Other sonicating durations are also possible (e.g., between about 1 minute and about 25 minutes, between 1 minute and 25 minutes, between about 5 minutes and about 15 minutes, between 5 minutes and 15 minutes, about 10 minutes, 10 minutes, combinations thereof, and durations therebetween). In some embodiments, sonicating 106 comprises applying sound energy at a power/volume ratio between about 50 W/gal (approx. 13 W/L) and about 300 W/gal (approx. 79 W/L), between 50 W/gal (approx. 13 W/L) and 300 W/gal (approx. 79 W/L), between about 100 W/gal (approx. 26 W/L) and about 150 W/gal (approx. 40 W/L), between 100 W/gal (approx. 26 W/L) and 150 W/gal (approx. 40 W/L), combinations thereof, and/or ratios therebetween. In some embodiments, sonicating 106 is at a frequency between about 38 kHz and about 40 kHz, or between 38 kHz and 40 kHz. The sonicating 106 may be at a temperature between about 40° C. and about 80° C., between 40° C. and 80° C., between about 50° C. and about 70° C., between 50° C. and 70° C., between about 55° C. and about 65° C. (e.g., about 60° C.), between 55° C. and 65° C. (e.g., 60° C.), combinations thereof, and/or temperatures included therein.

In embodiments in which the endoprosthesis is in a basket 206 during the soaking 104, the basket 206, including the endoprosthesis therein and residual nitric acid thereon, may be moved to a beaker (e.g., similar to the beaker 202) containing deionized water, for example by handling the basket 206 with forceps (e.g., comprising polytetrafluoroethylene (PTFE)). The endoprosthesis may remain in the basket throughout much or all of the method 100 or portions thereof

In some embodiments, sonicating 106 is performed twice per cycle, as indicated by the dashed line in FIG. 1 showing 1× repetition of the sonicating 106. In some embodiments, the endoprosthesis is transferred directly from the nitric acid of the soaking 104 to the deionized water of the sonicating 106 (e.g., without rinsing), so the endoprosthesis, and possibly the basket 206 or other hardware, may include residual nitric acid and/or much from the soaking 104 during the first instance of sonicating 106. The endoprosthesis may then be transferred directly from the first instance of the sonicating 106 to the deionized water of the second instance of the sonicating 106 (e.g., without rinsing). The endoprosthesis, and possibly the basket 206 or other hardware, may continue to include residual nitric acid and/or much from the soaking 104 and/or the first instance of the sonicating 106 during the second instance of sonicating 106, but after contact with deionized water baths in each instance of sonicating 106, such residual nitric acid and/or may only be trace. Additional repetitions of the sonicating 106 are also possible.

In some embodiments, the first instance of the sonicating 106 and the second instance of the sonicating 106 are at the same or substantially the same conditions. In some embodiments, at least one parameter (e.g., duration, temperature, power, frequency, bath volume, etc.) is different between the first instance of the sonicating 106 and the second instance of the sonicating 106.

Before, after, and/or during sonicating at box 106, the endoprosthesis may be rinsed with deionized water. In some embodiments, deionized water (e.g., due to sonicating 106 and/or due to rinsing) is removed with compressed air. In some embodiments, deionized water is removed by drying the endoprosthesis in an oven for between about 15 minutes and about 20 minutes or between 15 minutes and 20 minutes. Prior to the drying, the oven may have a stable temperature for at least about 15 minutes or at least 15 minutes, for example for about 30 minutes or for 30 minutes.

After soaking 104 and sonicating 106, the endoprosthesis may be inspected (e.g., under a microscope, an electron microscope, etc.) to see if the non-protective oxide has been removed at decision 108. In some embodiments, the inspecting 108 is under a microscope at 20× magnification. The inspecting 108 may concentrate on certain portions of the endoprosthesis, for example strand crossings and strand couplings for a woven stent, or narrow features such as insides of peaks for laser-cut stents. If the inspecting 108 reveals that the oxide has not been removed, the soaking 104 and sonicating 106 may be repeated n times. It will be appreciated that complete non-protective oxide removal may be most desirable, but that partial non-protective oxide removal may also be appropriate for some applications as long as the protective oxide is appropriate.

It will also be appreciated that the inspecting 108 may be omitted, for example after a total number n+1 of cycles of soaking 104 and sonicating 106 are previously established or set, for example based on user experience with the process and a particular type of endoprosthesis. In some embodiments, the number n is greater than 1, greater than 2, greater than 3, greater than 4, greater than 5, less than 15, less than 15, less than 14, less than 13, less than 12, less than 11, less than 10, less than 9, between 1 and 16, between 2 and 15, between 3 and 9, numbers therebetween, and other numbers n that may be deemed sufficient, for example based on determination of complete, sufficient, or appropriate non-protective oxide removal. It will also be appreciated that the inspecting 108 may be delayed until after a subset m of cycles, where m<n. In some embodiments, the number m is 2 such that 3 total soaking 104 and sonicating 106 cycles occur prior to the inspecting 108. In some embodiments, soaking 104 and sonicating 106 may be repeated for at least one additional cycle (e.g., for a total of n+2 cycles) even after the inspecting 108 determines that the non-protective oxide has been removed, for example for process 100 robustness.

In some embodiments, the cycles of soaking 104 and sonicating 106 are all identical or substantially identical (e.g., due only to operator or equipment differences). In some embodiments, the cycles of soaking 104 and sonicating 106 may include a different parameter in one or more of the cycles. For example one or more of concentration, duration, temperature, power, frequency, stirring, sonicating 106 repetition, bath volume, etc. may be adjusted.

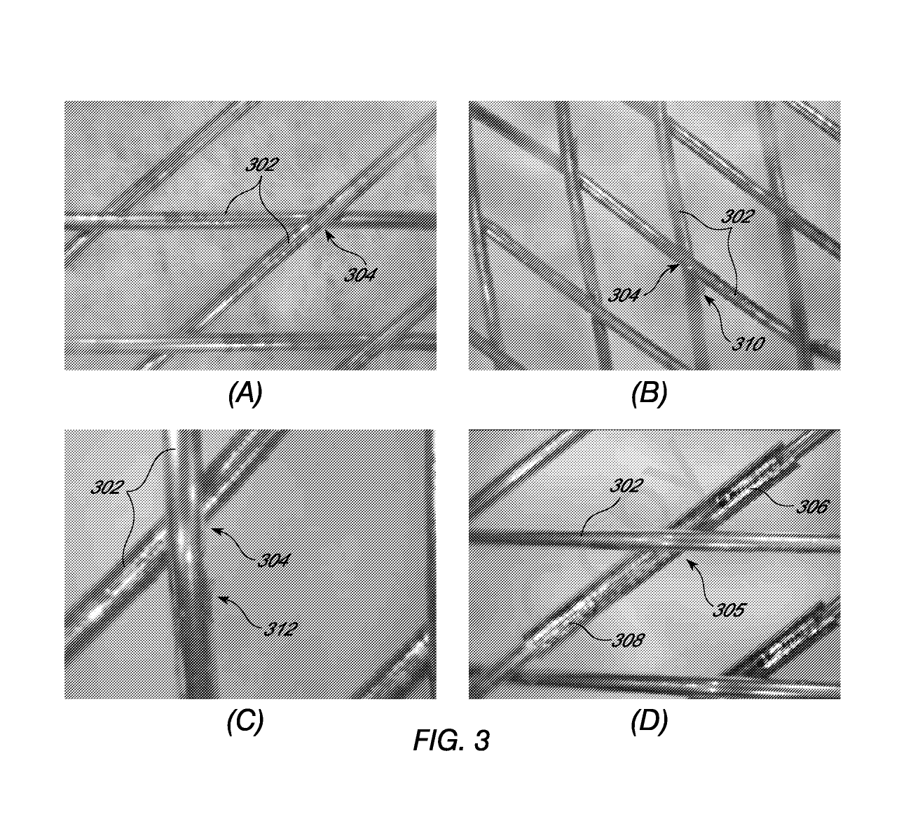

FIG. 3 illustrates examples of non-protective oxide delaminating from a surface of an endoprosthesis. The endoprosthesis includes a plurality of strands 302 comprising nitinol and oxide on the surface of the nitinol. The strands 302 are woven and cross at intersections 304. Ends of the strands 302 are coupled in a coupling device 306, which may be welded to the ends of the strands 302, as shown by the weld areas 308. The coupling device 306 may cross a strand 302 at an intersection 305. Further information about such an endoprosthesis may be found in U.S. Pat. Nos. 6,409,750 and 7,018,401 and U.S. Patent Pub. Nos. 2002/0151933 and 2008/0290076, which are each hereby incorporated by reference in its entirety and appended hereto. As described herein, intersections and/or crossings 304, 305 and coupling devices 306 may be subject to enhanced scrutiny during inspecting 308. The strands 302 and coupling devices 306 generally show two different colors, shiny silver where metal is exposed or protective oxide has formed and dull grey where non-protective oxide persists. Delamination of the non-protective oxide is visible, for example best seen in area 310 of FIG. 3b and area 312 of FIG. 3c. When non-protective oxide is visible during the inspecting 108, at least one more cycle of soaking 104 and sonicating 106 is generally used. In some embodiments, a certain quantity or level of remaining non-protective oxide during the inspecting 108 may result to more than additional cycle of soaking 104 and sonicating 106.

Sonicating 106 can cause premature failure of the endoprosthesis, for example by creating microfractures in the material of the endoprosthesis. The number of cycles n is preferably 11 or fewer, or the number of total cycles n+1 is preferably less 10 or fewer. In some embodiments, this amount of sonicating 106, even accounting for repetition within the sonicating 106, can reduce or minimize the chance of endoprosthesis failure due to microfracture creation during sonicating 106. Shorter nitric acid soak durations (e.g., about 1 hour or less, 1 hour or less) may increase the number of times n of repeating soaking and sonicating cycles to achieve removal of the non-protective oxide (e.g., up to 30, 40, or even 90 times). Increasing nitric acid soak duration (e.g., to greater than 1 hour) can reduce the number of times n of repeating soaking 104 and sonicating 106, thereby reducing the total duration of sonicating 106 and reducing the chances of endoprosthesis failure.

Although the precise mechanism for removal of non-protective oxide is not fully understood, it is believed that soaking 104 may cause a mild reaction between the nitric acid and the non-ordered titanium non-protective oxide and/or penetration of the nitric acid between the between the non-ordered ceramic non-protective oxide and the metal underneath. This mild reaction and/or penetration may build up compressive stresses due to the formation of a gap or space between the base metal and the non-ordered ceramic non-protective oxide. Repeated cycles of soaking 104 and sonicating 106 may further increase these compressive stresses at the oxide-metal interface, until the non-protective oxide can delaminate or peel off the metal surface during sonicating 106.

In some embodiments, the method 100 both removes the non-protective oxide and forms the protective oxide, even possibly simultaneously. For example, as the non-protective oxide sloughs off, a protective oxide may grow in its place. In some embodiments, growth of the protective oxide may enhance removal of the non-protective oxide as it intervenes between the base metal and the non-protective oxide. During and/or after the non-protective oxide is removed, a thin and uniform or substantially uniform protective oxide, for example having a thickness between about 30 Å and about 100 Å, between 30 Å and 100 Å, less than about 100 Å, less than 100 Å, less than about 50 Å, less than 50 Å, is formed during the method 100. The protective oxide may provide corrosion resistance to the endoprosthesis and/or may inhibit leaching of the underlying metal. The method 100 advantageously does not cause loss of base metal other than metal that oxidizes to form the protective oxide. For example, base metal is not lost due to etching or pitting.

The method 100 includes soaking in nitric acid for between about 30 minutes and about 45 minutes, between 30 minutes and 45 minutes, between about 30 minutes and about 60 minutes, or between 30 minutes and 60 minutes, at box 110. The soaking 110 may ensure that the protective oxide covers or substantially covers the endoprosthesis, for example even in areas where non-protective oxide sloughed off in the last cycle of soaking 104 and sonicating 106. The soaking 110 may be in accordance with ASTM standards for forming a thin passivating oxide (e.g., ASTM A967-05), or a modification thereof. Other methods for forming a uniform oxide are also possible. For example, the soaking 110 may instead comprise soaking in citric acid diluted in deionized water to between about 4 wt % and about 10 wt % or between 4 wt % and 10 wt % for about 20 minutes or 20 minutes at a temperature between about 21° C. and about 49° C. or between 21° C. and 49° C. (e.g., in accordance with ASTM A967-05, or a modification thereof) or other mild acids (e.g., acetic acid, ascorbic acid, salicylic acid, etc.) and/or boiling water.

Before, after, and/or during the soaking 110, the endoprosthesis may be rinsed with deionized water. For example with respect to any rinsing described herein, rinsing the endoprosthesis may include manually agitating a container (e.g., a beaker such as the beaker 204 of FIG. 2) containing deionized water for about 5 minutes or for 5 minutes. The rinse may include two cycles, each time in fresh deionized water for about 5 minutes or 5 minutes with manual agitation. Deionized water may be removed with compressed air.

After forming the soaking 110, the method ends at End 112. After End 112, the endoprosthesis is ready or substantially ready to be sterilized, installed in a delivery system, sold, implanted in a subject, etc.

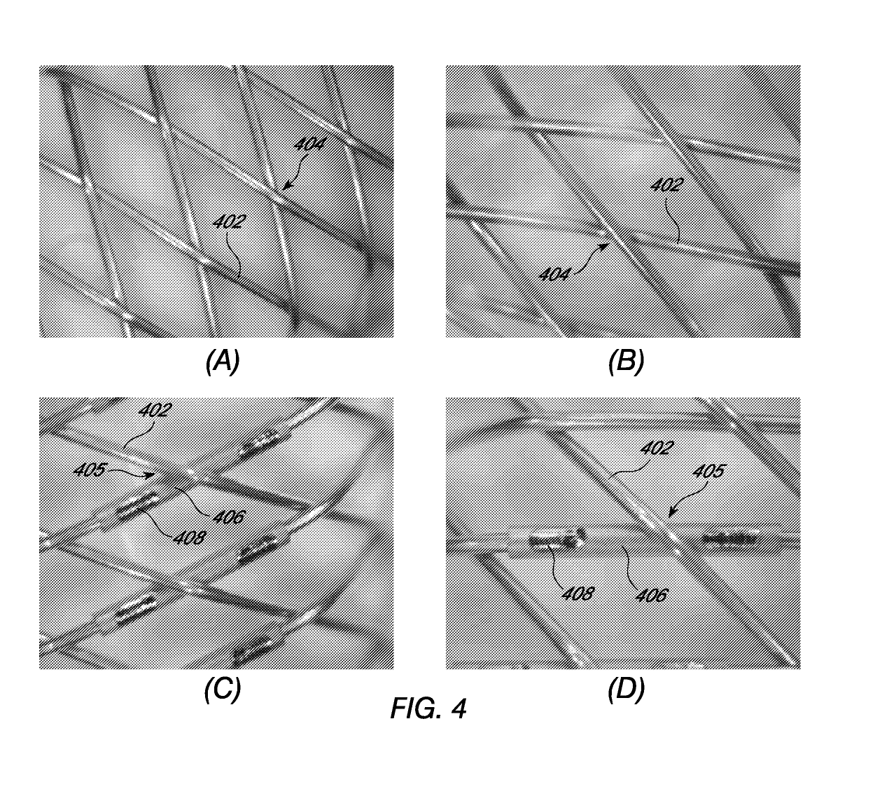

FIG. 4 illustrates examples of a passivated surface of an endoprosthesis. The endoprosthesis includes a plurality of strands 402 comprising nitinol and a thin and uniform or substantially uniform layer of oxide (e.g., having a thickness between about 30 Å and about 100 Å) on the surface of the nitinol, for example as a result of the methods described herein. The strands 402 are woven and cross at intersections 404. Ends of the strands 402 are coupled in a coupling device 406, which may be welded to the ends of the strands 402, as shown by the weld areas 408. The coupling device 406 may cross a strand 402 at an intersection 405. The strands 302 generally have a single color, a somewhat dull grey indicative of a thin and uniform or substantially uniform oxide over a metal.

After End 112, the endoprosthesis may be sterilized, for example to make the endoprosthesis suitable for sterile use in a human or animal body. In some embodiments, sterilizing the endoprosthesis comprises exposure to ethylene oxide (EtO) gas. For example, sterilization of the endoprosthesis after End 112 may include exposure in a sterilization chamber at a temperature between about 46° C. and about 57° C. and an EtO pressure between about 62 kiloPascals (kPA) and about 70 kPa for a duration between about 120 minutes and about 150 minutes.

In some embodiments, prior to soaking 104, an endoprosthesis including oxide is first sonicated. The sonicating before soaking 104 may be in deionized water for between about 5 minutes and about 20 minutes or between 5 minutes and 20 minutes. Other sonicating durations are also possible (e.g., between about 1 minute and about 25 minutes, between 1 minute and 25 minutes, between about 5 minutes and about 15 minutes, between 5 minutes and 15 minutes, about 10 minutes, 10 minutes, combinations thereof, and durations therebetween). The sonicating before soaking 104 may be in a solution including sodium hydroxide (NaOH) (e.g., Oakite Low Heat Cleaner 1, available from Chemetall GmbH) for between about 10 minutes and about 20 minutes or between 10 minutes and 20 minutes. In some embodiments, sonicating in NaOH before soaking 104 uses a power/volume ratio between about 50 W/gal (approx. 13 W/L) and about 300 W/gal (approx. 79 W/L), between 50 W/gal (approx. 13 W/L) and 300 W/gal (approx. 79 W/L), between about 100 W/gal (approx. 26 W/L) and about 150 W/gal (approx. 40 W/L), between 100 W/gal (approx. 26 W/L) and 150 W/gal (approx. 40 W/L), combinations thereof, and/or ratios therebetween. In some embodiments, sonicating in NaOH solution before soaking 104 is at a frequency between about 38 kHz and about k40 Hz or between 38 kHz and 40 kHz. In some embodiments, sonicating in NaOH solution before soaking 104 is followed by sonicating in deionized water, for example using parameters described herein for the sonicating 106. Such sonicating in deionized water may inhibit sodium, which can cause pitting of the underlying metal, from being present during the soaking 104.

Although the precise mechanism for non-protective oxide removal is not fully understood, it is believed that initially sonicating in deionized water, NaOH solution, and/or NaOH solution and deionized water may create microfissures in the non-protective oxide, increasing the penetration of nitric acid during the soaking 104, for example in accordance with the theoretical non-protective oxide removal mechanisms described herein. Before, after, and/or during sonicating before soaking 104, the endoprosthesis may be rinsed with deionized water.

Non-protective oxide removal processes such as electropolishing and sandblasting generally are performed one device at a time, or, with special tooling, perhaps several at a time, but not in large batches due to concerns about removing too much underlying material. In some embodiments, a plurality of devices can advantageously be processed using the method 100 simultaneously in a batch. For example, the method 100 removes little to no material underlying the non-protective oxide such that the danger of material removal due to overprocessing is reduced or negligible. The batch may include, for example, greater than about 25 devices, greater than about 50 devices, greater than about 100 devices, greater than about 250 devices, greater than about 500 devices, greater than 25 devices, greater than 50 devices, greater than 100 devices, greater than 250 devices, greater than 500 devices, and the like. Factors affecting batch size may include, for example, tooling such as beaker size and basket size, ability to control temperature, stirring, sonication, etc., and the like. There is no theoretical maximum batch size as factors affecting batch size may be modified as desired, although other rate-limiting steps such as quality control and device fabrication may reduce the reasonable size of batches.

In some embodiments, prior to forming the soaking 110 and after the sonicating 106 in the last cycle, the method 100 further comprises sonicating the endoprosthesis in deionized water, NaOH solution, and/or NaOH solution and deionized water. Before, after, and/or during sonicating before soaking 110, the endoprosthesis may be rinsed with deionized water.

The method 100 may be used in combination with other non-protective oxide removal processes or modifications (e.g., shorter versions) thereof, for example to provide a cleaner or more uniform protective oxide.

Table 2 shows oxide thickness measurements of six samples of SUPERA® stents that were passivated using the method 100 described herein.

TABLE 2
Oxide Layer Characterization - AES Sputtering

| Sample | Site | Oxide Thickness (Å) |
|---|---|---|
| 1 | Coupling | 103 |
| | Wire | 87 |
| 2 | Coupling | 70 |
| | Wire | 59 |
| 3 | Coupling | 60 |
| | Wire | 40 |
| 4 | Coupling | 54 |
| | Wire | 56 |
| 5 | Coupling | 50 |
| | Wire | 50 |
| 6 | Coupling | 76 |
| | Wire | 64 |

Oxide thickness was measured where the oxygen concentration drops by half of its maximum and/or where the oxygen plot crosses the nickel plot.

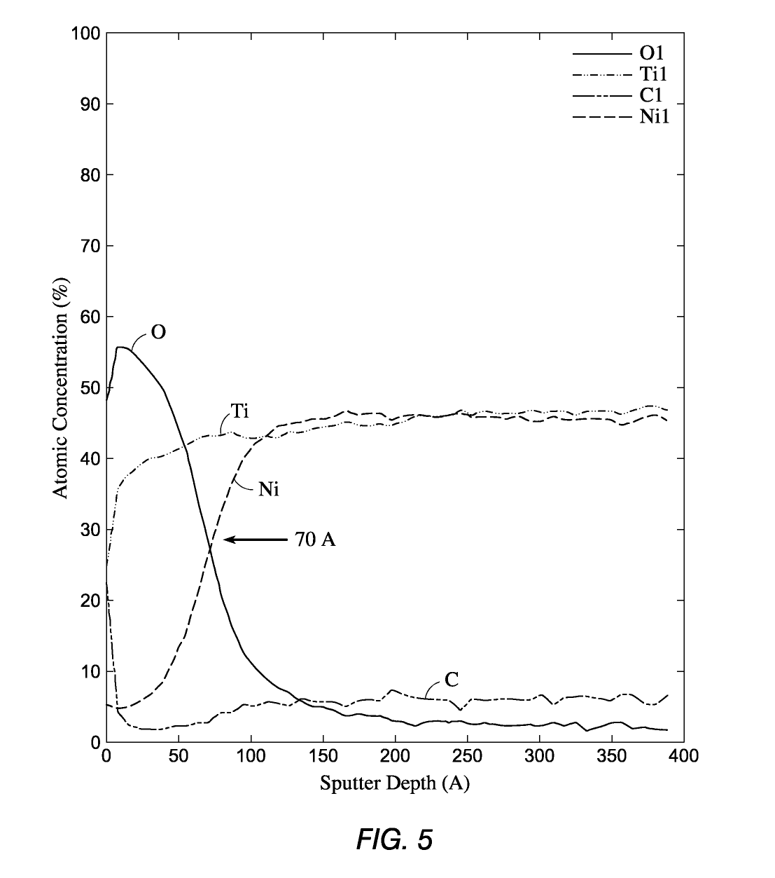

FIG. 5 is an Auger depth profile of a first portion of a passivated surface of a sterilized endoprosthesis. With reference to Table 2, the sterilized endoprosthesis is Sample 2, and the first portion is the coupling (e.g., the coupling device 408 of FIG. 4). The depth of the oxide is about 70 Å, indicated by the depth at the crossing of the oxygen (O) and nickel (Ni) lines and/or the depth at about half of the maximum oxide concentration (e.g., at about 28 atomic %). Although nickel is still present below this depth, the oxygen concentration is higher than the nickel concentration such that the oxygen and titanium forms protective oxide free of nickel presence.

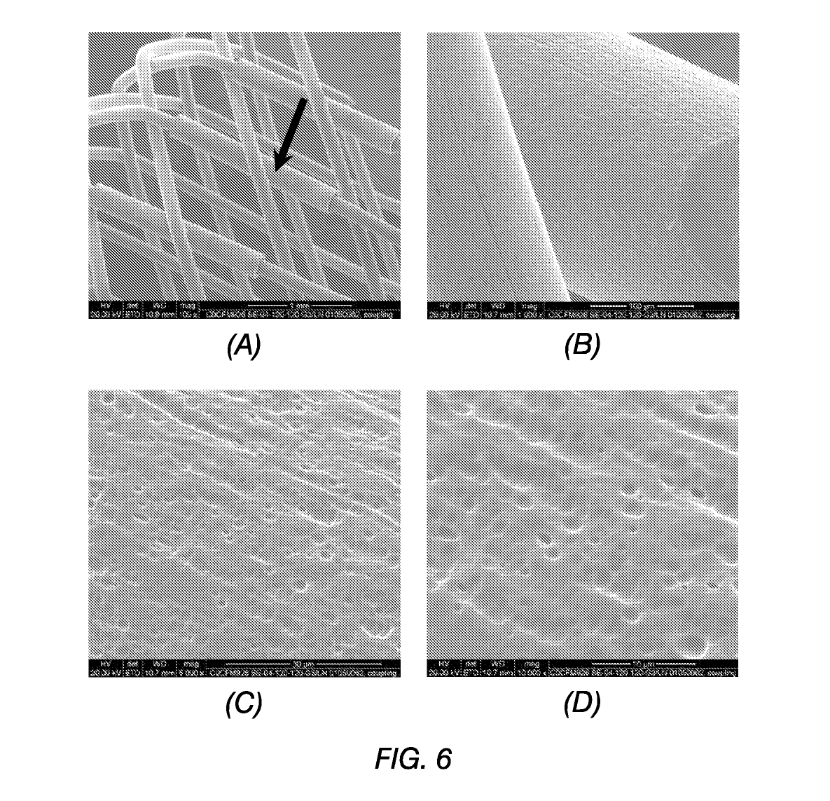

FIG. 6 illustrates the coupling of Sample 2 at various magnifications under a scanning electron microscope (SEM). FIG. 6a is at 100×; FIG. 6b is at 1,000×; FIG. 6c is at 5,000×; and FIG. 6d is at 10,000×. FIGS. 6b-6d are approximately in the area of the arrow in FIG. 6a. FIG. 6 shows that there is no non-protective oxide remaining on the coupling, and that the protective oxide is substantially uniform, that the process did not cause pitting of the base metal.

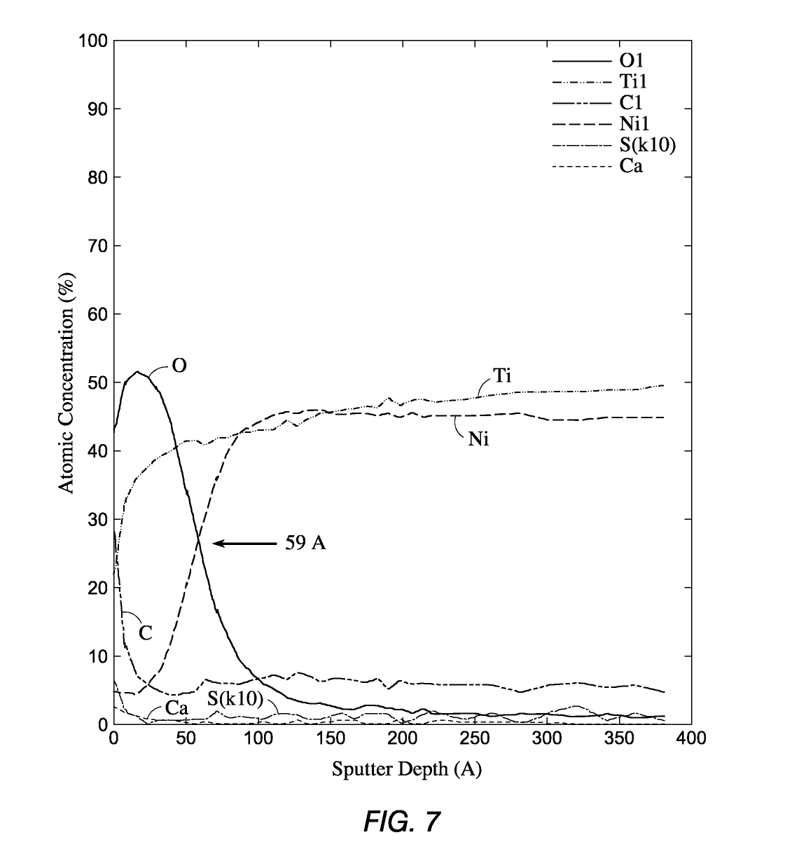

FIG. 7 is an Auger depth profile of a second portion of the passivated surface of the sterilized endoprosthesis of FIG. 6. With reference to Table 2, the sterilized endoprosthesis is Sample 2, and the second portion is the wire (e.g., the strand 402 of FIG. 4). The depth of the oxide is about 59 Å, indicated by the depth at the crossing of the oxygen and nickel lines and/or the depth at about half of the maximum oxide concentration (e.g., at about 28 atomic %).

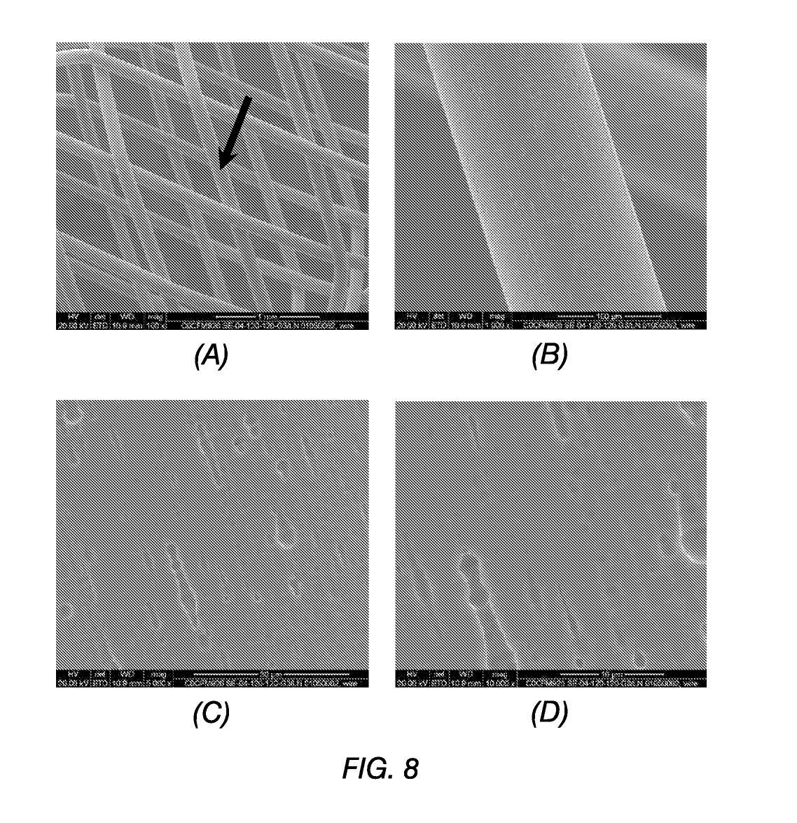

FIG. 8 illustrates the strand of Sample 2 at various magnifications under a SEM. FIG. 8a is at 100×; FIG. 8b is at 1,000×; FIG. 8c is at 5,000×; and FIG. 8d is at 10,000×. FIGS. 8b-8d are approximately in the area of the arrow in FIG. 8a. FIG. 8 shows that there is no non-protective oxide remaining on the strand, that the protective oxide is substantially uniform, and that the process did not cause pitting of the base metal.

Although the invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Thus, it is intended that the scope of the invention herein disclosed should not be limited by the particular embodiments described above.

### CERTAIN EMBODIMENTS

1. A method of treating a device, the method comprising:
first soaking the device in nitric acid for greater than 1 hour;
after first soaking the device, first sonicating the device in deionized water for between about 5 minutes and about 20 minutes; and
after first sonicating the device, repeating, at least once:
   soaking the device in nitric acid for greater than 1 hour, and
   after soaking the device in the nitric acid, sonicating the device in deionized water for between about 5 minutes and about 20 minutes.

2. The method of Embodiment 1, wherein the device comprises nitinol.

3. The method of Embodiment 2, wherein, before first soaking the device, the device comprises non-protective oxide at least partially covering the nitinol.

4. The method of any of Embodiments 1-3, wherein repeating the soaking and sonicating is at least 2 times.

5. The method of any of Embodiments 1-4, wherein repeating the soaking and sonicating is less than 10 times.

6. The method of any of Embodiments 1-5, wherein at least one of first soaking and soaking during repeating includes soaking the device in nitric acid for between greater than 1 hour and about 2 hours.

7. The method of any of Embodiments 1-5, wherein at least one of first soaking and soaking during repeating includes soaking the device in nitric acid for between greater than 1 hour and about 3 hours.

8. The method of any of Embodiments 1-5, wherein at least one of first soaking and soaking during repeating includes soaking the device in nitric acid for between greater than 1 hour and about 4 hours.

9. The method of any of Embodiments 1-8, wherein at least one of first sonicating and sonicating during repeating includes sonicating the device in deionized water for about 10 minutes.

10. The method of any of Embodiments 1-9, wherein at least one of first soaking and soaking during repeating includes stirring during soaking.

11. The method of Embodiment 10, wherein stirring is between about 200 rpm and about 300 rpm.

12. The method of any of Embodiments 1-11, wherein at least one of first soaking and soaking during repeating includes sonicating during soaking.

13. The method of any of Embodiments 1-12, wherein at least one of first sonicating and sonicating during repeating includes sonicating the device in deionized water at least two times.

14. The method of Embodiment 13, wherein at least one of first sonicating and sonicating during repeating includes sonicating the device in deionized water for about 10 minutes at least two times.

15. The method of any of Embodiments 1-14, wherein at least one of first sonicating and sonicating during repeating includes rinsing nitric acid from the device.

16. The method of any of Embodiments 1-15, further comprising, during repeating, inspecting the device.

17. The method of Embodiment 16, wherein inspecting comprises using at least one of an optical microscope and a scanning electron microscope.

18. The method of Embodiment 16 or 17, wherein inspecting the device influences a number of times of repeating.

19. The method of any of Embodiments 1-18, further comprising, after repeating, lastly soaking the device in nitric acid for between about 30 minutes and about 60 minutes.

20. The method of any of Embodiments 1-18, further comprising, after repeating, lastly soaking the device in nitric acid for between about 30 minutes and about 45 minutes.

21. The method of any of Embodiments 1-20, further comprising, before first soaking, initially sonicating the device.

22. The method of Embodiment 21, wherein initially sonicating the device includes sonicating in a solution including sodium hydroxide.

23. The method of Embodiment 21 or 22, wherein initially sonicating the device includes sonicating in deionized water.

24. The method of any of Embodiments 1-23, wherein, after the method, the device comprises an oxide layer having a thickness between about 30 Å and about 100 Å.

25. The method of any of Embodiments 1-24, wherein the device comprises an endoprosthesis stent.

26. The method of Embodiment 25, wherein the endoprosthesis comprises a stent.

27. The method of Embodiment 26, wherein the stent comprises a woven stent.

28. The method of Embodiment 27, wherein the woven stent comprises nitinol strands.

29. The method of Embodiment 26, wherein the stent comprises a laser-cut stent.

30. The method of Embodiment 29, wherein the laser-cut stent comprises nitinol.

31. The method of any of Embodiments 1-30, the method comprises processing a plurality of said devices in a batch.

32. The method of Embodiment 31, wherein the batch comprises at least about 25 the devices.

1. A method of treating a device, the method comprising:
first soaking the device in nitric acid for greater than 1 hour;
after first soaking the device, first sonicating the device in deionized water for between about 5 minutes and about 20 minutes; and
after first sonicating the device, repeating, at least once:
soaking the device in nitric acid for greater than 1 hour, and
after soaking the device in the nitric acid, sonicating the device in deionized water for between about 5 minutes and about 20 minutes.

2. The method of claim 1, wherein the device comprises nitinol.

3. The method of claim 2, wherein, before first soaking the device, the device comprises non-protective oxide at least partially covering the nitinol.

4. The method of claim 1, wherein repeating the soaking and sonicating is at least 2 times.

5. The method of claim 1, wherein repeating the soaking and sonicating is less than 10 times.

6. The method of claim 1, wherein at least one of first soaking and soaking during repeating includes soaking the device in nitric acid for between greater than 1 hour and about 2 hours.

7. The method of claim 1, wherein at least one of first soaking and soaking during repeating includes soaking the device in nitric acid for between greater than 1 hour and about 3 hours.

8. The method of claim 1, wherein at least one of first soaking and soaking during repeating includes soaking the device in nitric acid for between greater than 1 hour and about 4 hours.

9. The method of claim 1, wherein at least one of first sonicating and sonicating during repeating includes sonicating the device in deionized water for about 10 minutes.

10. The method of claim 1, wherein at least one of first soaking and soaking during repeating includes stirring during soaking.

11. The method of claim 10, wherein stirring is between about 200 rpm and about 300 rpm.

12. The method of claim 1, wherein at least one of first soaking and soaking during repeating includes sonicating during soaking.

13. The method of claim 1, wherein at least one of first sonicating and sonicating during repeating includes sonicating the device in deionized water at least two times.

14. The method of claim 13, wherein at least one of first sonicating and sonicating during repeating includes sonicating the device in deionized water for about 10 minutes at least two times.

15. The method of claim 1, wherein at least one of first sonicating and sonicating during repeating includes rinsing nitric acid from the device.

16. The method of claim 1, further comprising, during repeating, inspecting the device.

17. The method of claim 16, wherein inspecting comprises using at least one of an optical microscope and a scanning electron microscope.

18. The method of claim 16, wherein inspecting the device influences a number of times of repeating.

19. The method of claim 1, further comprising, after repeating, lastly soaking the device in nitric acid for between about 30 minutes and about 60 minutes.

20. The method of claim 1, further comprising, after repeating, lastly soaking the device in nitric acid for between about 30 minutes and about 45 minutes.

21. The method of claim 1, further comprising, before first soaking, initially sonicating the device.

22. The method of claim 21, wherein initially sonicating the device includes sonicating in a solution including sodium hydroxide.

23. The method of claim 21, wherein initially sonicating the device includes sonicating in deionized water.

24. The method of claim 1, wherein, after the method, the device comprises an oxide layer having a thickness between about 30 angstroms and about 100 angstroms.

25. The method of claim 1, wherein the device comprises an endoprosthesis.

26. The method of claim 25, wherein the endoprosthesis comprises a stent.

27. The method of claim 26, wherein the stent comprises a woven stent.

28. The method of claim 27, wherein the woven stent comprises nitinol strands.

29. The method of claim 26, wherein the stent comprises a laser-cut stent.

30. The method of claim 29, wherein the laser-cut stent comprises nitinol.

31. The method of claim 1, the method comprises processing a plurality of said devices in a batch.

32. The method of claim 31, wherein the batch comprises at least about 25 the devices.
